(19) United States
(12) Patent Application Publication
(10) Pub. No.: US 2014/0074959 A1
(43) Pub. Date: Mar. 13, 2014

(54) CLIENT SIDE MEDIA STATION GENERATION

(71) Applicants: Thomas Alsina, Mountain View, CA (US); Kenley Sun, Cupertino, CA (US); Arvind S. Shenoy, San Jose, CA (US); Andrew Wadycki, San Mateo, CA (US); William Bedford Turner, Campbell, CA (US); David Thomas Wilson, Campbell, CA (US); Jason James St. Pierre, Palo Alto, CA (US); Jayasurya Vadrevu, Saratoga, CA (US)

(72) Inventors: Thomas Alsina, Mountain View, CA (US); Kenley Sun, Cupertino, CA (US); Arvind S. Shenoy, San Jose, CA (US); Andrew Wadycki, San Mateo, CA (US); William Bedford Turner, Campbell, CA (US); David Thomas Wilson, Campbell, CA (US); Jason James St. Pierre, Palo Alto, CA (US); Jayasurya Vadrevu, Saratoga, CA (US)

(73) Assignee: Apple Inc., Cupertino, CA (US)

(21) Appl. No.: 13/609,220

(22) Filed: Sep. 10, 2012

(51) Int. Cl. G06F 15/16; G06F 15/167

(52) U.S. Cl. 709/213; 709/219

(57) ABSTRACT

To generate a media station, a client device can receive a candidate media item playlist and media playback rules corresponding to the media station. When a new media item is needed for the media station, the client device can apply the media playback rules to a next media item in the list of candidate media items. The playback rules can be used to determine whether the next media item is currently eligible for playback. Additionally, the client device can receive a candidate invitational content item playlist and invitational content playback rules corresponding to the media station. In response to detecting an invitational content triggering action, the client device can apply the invitational content item rules to the candidate invitational content item playlist to select at least one invitational content item to present in the media stream.

### BACKGROUND

1. Technical Field

The present disclosure relates to generating a media station and more specifically to generating a media station on a client device through the application of one or more playback rules to locally cached media items.

2. Introduction

Many users enjoy consuming content such as music or television shows without having to purchase or maintain a copy of the media item. Traditionally, users could accomplish this through radio or television broadcasting. Each station can broadcast a sequence of media items based around the station's programming model, e.g. country music, rock music, talk radio, sports programming, etc. In some cases, the programming model can vary with the day or even time of day, but overall the programming on a particular station is fairly structured. While traditional radio and television broadcasting provide streams of content, which in many cases are free to the end user, traditional broadcasting suffers from a number of drawbacks. On such drawback is that the content distribution model is very rigid. In order to consume the content, a user must tune their device to a particular station. Once on the station, the user is only able to consume the content scheduled for that time period.

The widespread use of the Internet and portable electronic devices has made it possible to offer more flexible content distribution and consumption models. For example, in many cases, a user can carry around a large media collection on a small client device. Since most client media playback applications permit users to create playlists of media items, a user can easily consume a sequence of media items whenever the client device is available. Additionally, many client devices include features that will generate playlist automatically from the media items in the user's media library. Such features can create a content consumption experience similar to that of traditional radio or television broadcasting, but one that permits the user to control when and how the media is consumed. However, under this model, the content consumption is limited to those media items on the device.

Alternatively, Internet based content streaming is a popular service available to users with an Internet connection. Such services allow a user to stream an individual content sequence to an Internet connected device. The individual content sequence can be constructed on demand so that a user is not entering the content after it has already started. Additionally, some content streaming services allow users to pause and skip content. Furthermore, the content sequence can be based on user preferences, thereby allowing a user to create a custom media channel or station. Unfortunately, Internet based content streaming services require a persistent connection to the service's content server. If the connection is disrupted, such as through a complete loss of connection or a significant decrease in available bandwidth, the content streaming will also be disrupted. Additionally, continuous content streaming places a number of burdens on a client device. This makes the currently available content streaming and broadcasting models impracticable for many situations.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for generating a media station on a client device. A media station can be a sequence of media items that can be played or executed by a media station player on a client device. A media station can be a continuous sequence of content such that as one content item completes playback a next item can begin. The playback process of a continuous media stream can repeat until a user takes an action to terminate or temporarily delay the playback. A media station can also be defined as a finite sequence of media items. Furthermore, a media station can be defined to playback a homogeneous or heterogeneous sequence of media items.

To generate a media station, a client device can receive a list of candidate media items for the media station from a media content server. The media content server can construct the list of candidate media items by applying one or more media playlist generation rules applicable to the media station. A media playlist generation rule can define which media items are candidates for playback on a particular media station. A variety of media playlist generation rules are possible, such as rules defined by a media station sponsor, rules based on matching metadata, rules based on similarity to a seed item, rules based on user characteristics, and/or rules based on other criteria, e.g. genre, artist, or record label.

The list of candidate media items can specify a media item identifier for each candidate media item and metadata describing the media item. Furthermore, in some cases, the list can include a reference to a storage location for the media item. If the media item already exists in the user's media library, the list of candidate media items can exclude a reference to a storage location, the reference can be a null reference, or the reference can be to a location in the user's media library. A null reference can be used to indicate that the media item exists in the media library, and thus the client device can be configured to identify the storage location. Otherwise, the reference can be to a locally cached copy of the media item that was downloaded to the client device for playback on the media station.

The client device can also receive one or more media playback rules. A media playback rule can define constraints on the playback order of the media items in the media station. A variety of different media playback rules are possible. In some cases, a media playback rule can be based on legal regulations, licensing agreements, sponsorship agreements, and/or user actions. When a next media item is needed, the client device can select a media item identifier from the list of candidate media items and apply one or more media playback rules to determine if the selected media item is currently eligible for playback. If the media item is not eligible, the client device can continue to select media items from the list and apply the one or more media playback rules until a currently eligible media item is found.

In some configurations, a media station can also include invitational content, such as advertisements. The invitational content can be used as a source of revenue and/or to subsidize a media station so that the media items can be provided to end users free of charge or for a reduced fee. In some cases, the invitational content can be displayed in conjunction with a media item or media item representation. Invitational content can also be presented to a user in a manner that prevents or blocks the playback of a next media item or a next segment of a media item.

To include invitational content in the media station playback, the client device can receive a list of candidate invitational content from an invitational content server. The invitational content server can construct the list of candidate invitational content items by applying one or more invitational content playlist generation rules applicable to the media station. An invitational content playlist generation rule can define which items of invitational content are candidates for playback on a particular media station. A variety of invitational content playlist generation rules are possible, such as rules defined by a media station sponsor, rules based on matching metadata, rules based on similarity to a seed item, rules based on user characteristics, and/or rules based on other criteria, e.g. genre, artist, media type, presentation type, bandwidth requirements, processor requirements, client device type, etc. The list of candidate invitational content items can include a unique invitational content item identifier, an invitational content item, and/or associated metadata for each invitational content item in the list.

The client device can also receive one or more invitational content playback rules. An invitational content playback rule can define constraints on the playback order. In some cases, an invitational content playback rule can be based on matching metadata. An invitational content playback rule can also be based on media item playback. Additionally, an invitational content playback rule can also be time based.

The client device can be configured to detect the occurrence of an invitational content triggering event. An invitational content triggering event can include launching a media station application; initiating a new media station; completing playback of a media item; activating a particular feature of a user interface, e.g. a predefined screen in the user interface; moving the device in a predefined manner, e.g. detecting movement using an accelerometer; moving the device within a defined distance of a predefined sensor, e.g. a proximity sensor; and/or some other user action, such as pausing for a predetermined period of time or skipping a media item. In response to detecting an invitational content triggering event, the client device can apply one or more invitational content playback rules to determine if an invitational content item can be presented. Furthermore, the client device can apply one or more invitational content playback rules to select an invitational content item to present.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an exemplary exchange of data to initiate a media station;

FIG. 3 illustrates an exemplary media content server configuration;

FIG. 4 illustrates an exemplary invitational content server configuration;

FIG. 5 illustrates an exemplary client device configuration;

FIG. 6a illustrates an exemplary initial set-up of a candidate media playlist and media queue;

FIG. 6b illustrates an exemplary scenario of identifying a first media item eligible for playback;

FIG. 6c illustrates an exemplary scenario of identifying a next media item eligible for playback;

FIG. 7 illustrates an exemplary method for identifying a next media item;

FIG. 8 illustrates a first exemplary method for identifying a next invitational content item;

FIG. 9 illustrates a second exemplary method for identifying a next invitational content item;

FIG. 10 illustrates an exemplary overview of a media station generation on a client device;

FIG. 11 illustrates an exemplary method for generating a media station on a client device; and

FIG. 12 illustrates an exemplary system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for an improved way to generate a media channel of media items that can be consumed on a client device. A media channel or media station can be a sequence of media items that can be played or executed by a media station player on a client device. The media station player can be any application capable of media item playback, such as an aspect of webpage, a plug-in, a client-side application, etc. In some cases, a media station can be a continuous sequence of content such that as one content item completes playback a next item begins. The playback process of a continuous media stream can repeat until a user takes an action to terminate or temporarily delay the playback, such as quitting the application, switching to a different media station, pausing playback, or skipping a media item. However, a media station can also be defined to be a finite sequence of media items. A media station can be homogeneous or heterogeneous. That is, a media station can be designed to playback media items all of the same media type or of different media types. For example, a homogeneous media station can playback only audio media items or only video media items. In another example, a heterogeneous media station can playback a mix of audio media items and video media items.

A media station can be constructed such that media items added to the media station's content stream satisfy a programming model. In some cases, the programming model can be expressed as one or more rules or constraints. A type of rule can be a media playlist generation rule. A media playlist generation rule can define which media items are candidates for playback on a particular media station. A media playlist generation rule can explicitly define which media items can be played on a particular station. A variety of media playlist generation rules are possible. In some cases, a media playlist generation rule can even specify the order of the media item playback. A media playlist generation rule can also be defined based on one or more general constraints or predefined criteria, such as genre, artist, or record label. Additionally, a media playlist generation rule can be defined in terms of a seed item, such as a media item or artist. A media playlist generation rule based on a seed media item can also include a measure of similarity. By applying a seed based media playlist generation rule, media items determined to be sufficiently similar to the seed item can be selected as a candidate for playback on the media station. Furthermore, a media playlist generation rule can be defined based on user characteristics or demographic information. For example, a media playlist generation rule can specify the user characteristic values of male and 18-22. Using this playlist generation rule, media items can be selected that are determined to match the user characteristic values. In some cases, this determination can be based on metadata associated with the media items. A media playlist generation rule can also be based on user preferences, such as user specified likes or dislikes, or even parental control preferences.

In some cases, a media playlist generation rule can be station specific. For example, a media playlist generation rule can specify a genre for a media station. However, a playlist generation rule can also be station independent. For example, a media playlist generation rule can specify one or more user characteristics, such as user characteristics associated with a user of a client device requesting the media station. Such a media playlist generation rule can be applied in conjunction with one or more other media generation rules, such as station specific media generation rules, to generate a media station that is further customized to a particular end-user requesting the media station. In some cases, the selection of candidate media items for a media station can be based on the application of more than one media playlist generation rule.

Another type of rule can be a media playback rule. A media playback rule can define constraints on the playback order of the media items in the media station. A variety of different media playback rules are possible. In some cases, a media playback rule can be based on legal regulations, such the Digital Millennium Copyright Act (DMCA), licensing agreements, sponsorship agreements, and/or user actions. For example, a media playback rule based on a legal regulation may prohibit the playback of more than three songs by an artist in a one-hour time period. In another example, a media playback rule based on a legal regulation may prohibit the playback of more than three songs by an artist within a sequence of 15 songs. In a further example, a media playback rule based on a licensing agreement may relax the requirements of a legal regulation and allow the playback of at most 5 songs by an artist covered by the licensing agreement in a one-hour time period. In yet another example, a media station sponsored by a particular record label may define a media playback rule that completely prohibits playback of media items from a competitor record label or limits the number of media items from the competitor record label during a specified time period, such as one-hour. In still a further example, a media playback rule can be defined to limit the number of media items skipped by a user in a time interval, such as three skips in a one-hour time period. Such a media playback rule may be desirable if a sponsor of a media station or a media item provider is still required to pay for the media item. A media playlist generation rule can also be based on user preferences, such as user specified likes or dislikes, or even parental control preferences.

To apply some media playback rules, media playback historical data may be required. In some cases, media playback historical data can be maintained for only as long as is required to ensure that one or more media playback rules and/or any other rules are satisfied. For example, for a time based media playback rule, media playback historical data can be maintained for only as long as the longest time period, such as one-hour. In another example, for a media item sequence based media playback rule, media playback historical data can be maintained for only as long as the longest sequence length.

In some cases, a media playback rule can be station specific. For example, a media playback rule can apply exclusively to a sponsored or curated station. Therefore, any media playback historical data necessary to enforce the station specific media playback rule can be reset upon a switch from a first media station to a second media station. For example, media playback historical data used by a sponsor defined media playback rule, which limits playback of media items from a competitor during a specified time interval, can be reset upon a switch in media stations. However, a media playback rule can also be station independent and therefore the corresponding media playback historical data can also be station independent. For example, a rule based on a legal regulation that prohibits the playback of more than two songs from a single album in a 15-minute period can be applicable across media stations.

In some configurations, a media station can also include invitational content, such as advertisements. The invitational content can be used as a source of revenue and/or to subsidize a media station so that the media items can be provided to end users free of charge or for a reduced fee. In some cases, the invitational content can be displayed in conjunction with a media item or media item representation. For example, an invitational content item can be presented in a banner ad displayed with a music album cover or during the playback of a television show. Invitational content can also be presented to a user in a manner that prevents or blocks the playback of a next media item or a next segment of a media item. For example, upon the completion of the playback of a music item, but before beginning playback of a new music item, an invitational content item can be presented in the media stream. In another example, a television show or video can be divided into segments. Upon the completion of a segment, but before beginning playback of next segment, an invitational content item can be presented on the media station.

The selection and/or display of invitational content on a media station can be based on one or more rules or constraints. A type of rule can be an invitational content playlist generation rule. An invitational content playlist generation rule can define which items of invitational content are candidates for playback on a particular media station. An invitational content playlist generation rule can explicitly define which invitational content items can be played on a particular station. For example, a sponsor of a media station may define an invitational content playlist generation rule that specifies particular invitational content items that can be played on the sponsored station. An invitational content playlist generation rule can also be defined based on user characteristics or demographic information. For example, an invitational content playlist generation rule can specify the user characteristic values of female and 35-40. Using this invitational content playlist generation rule, invitational content items can be selected that are determined to match the user characteristic values. In some cases, this determination can be based on metadata associated with the invitational content items. Additionally, an invitational content playlist generation rule can be defined based on one or more general constraints, such as genre, media type, presentation type, bandwidth requirements, processor requirements, client device type, etc. Furthermore, an invitational content playlist generation rule can be defined in terms of a seed item. An invitational content playlist generation rule based on a seed item can also include a measure of similarity. By applying a seed based invitational content playlist generation rule, invitational content items determined to be sufficiently similar to the seed item can be selected as candidates for playback on the media station. An invitational content playlist generation rule can also be defined based on matching metadata. For example, a media station can have associated metadata that describes the media station and each item of invitational content can have associated metadata describing the item of invitational content. Items of invitational content with sufficiently matching metadata, as defined by the rule, can be selected as candidate invitational content.

In some cases, an invitational content playlist generation rule can be station specific. For example, an invitational content playlist generation rule can specify a presentation type or genre for a media station. However, an invitational content playlist generation rule can also be station independent. For example, an invitational content playlist generation rule can specify one or more user characteristics, such as user characteristics associated with a user of a client device requesting the media station. In some cases, such an invitational content playlist generation rule can be applied in conjunction with one or more other station specific invitational content generation rules, such as station specific rules, to generate a media station that is further customized to a particular end-user requesting the media station. In some cases, the selection of candidate invitational content for a media station can be based on the application of more than one invitational content playlist generation rule.

Another type of rule can be an invitational content playback rule. An invitational content playback rule can define constraints on the playback order. In some cases, an invitational content playback rule can be based on matching metadata. For example, an invitational content playback rule can be defined to identify an invitational content item with sufficiently matching metadata to a just completed media item, a next to play media item, or a currently playing media item. An invitational content playback rule can also be based on media item playback. For example, an invitational content playback rule can specify a number of media items played between a presentation of a first and second invitational content items. Additionally, an invitational content playback rule can also be time based. For example, an invitational content playback rule can specify a minimum time between the playback of a first item of invitational content and a second item of invitational content. Therefore, if a second item of invitational content is requested for the media station and the minimum time interval has not yet been reached, the request can be denied and a second item of invitational content will not be presented at that time. In another example, an invitational content playback rule can specify a maximum time interval between the playback of a first item of invitational content and a second item of invitational content. Therefore, if another rule has not been satisfied, such as a number of media items played because a user paused the station, then a second item of invitational content can still be displayed using the maximum time rule. Furthermore, an invitational content playback rule can be sponsor defined. For example, a sponsor of a sponsored station can specify one or more constraints regarding what invitational content can be presented, how it can be presented, and/or when it can be presented.

In some cases, an invitational content playback rule can also define the presentation method of an invitational content item. For example, a rule can define whether an invitational content item is presented as a banner ad or as a content item in the content stream that blocks playback of a next media item. In some cases, a presentation method rule can also be based on factors such as number of media items played; time interval since last invitational content item displayed using a particular presentation method; type of user interaction, e.g. pause or skip; and/or client device type.

An invitational content playback rule can also define an invitational content item type. In some cases, a rule can define a particular content item type based on current user interactivity or features currently active on the device. For example, a rule can specify video based invitational content when a user is actively interacting with the device. In another example, a rule can specify audio based invitational content when the display on the client device is off.

To apply some invitational content playback rules, media playback historical data and/or invitational content playback historical data may be required. For example, an invitational content playback rule based on a number of playbacks between a first and second invitational content item can require playback historical data. In some cases, playback historical data can be maintained for only as long is required to ensure that one or more invitational content playback rules are satisfied. For example, for a time based invitational content playback rule, playback historical data can be maintained for only as long as the longest time period, such as one-hour. In another example, for a media item sequence based invitational content playback rule, media playback historical data can be maintained for only as long as the longest sequence length.

In some cases, an invitational content playback rule can be station specific. For example, an invitational content playback rule can apply exclusively to a media station associated with a sponsorship agreement. Therefore, any playback historical data that is only necessary to enforce the station specific invitational content playback rule can be reset upon a switch from a first media station to a second media station. For example, invitational content playback historical data used by a sponsor defined invitational content playback rule, which limits playback of invitational content items from a competitor during a specified time interval, can be reset upon a switch in media stations. However, an invitational content playback rule can also be station independent and therefore the corresponding playback historical data can also be station independent. For example, a rule based on an overall time period between presentation of a first and second invitational content items can be applicable across media stations.

Using the present technology it is possible to improve media channel generation such that it decreases the burden on client devices and can be used in situations with less reliable or inconsistent Internet connections. An aspect of the present technology that aids in the improvement involves caching a larger collection of content on a client device. The caching makes it possible to shift to the client device at least a portion of the decision-making regarding which content to present next. In some configurations, a list of candidate media items, a list of candidate invitational content, one or more media playback rules, and/or one or more invitational content playback rules can be cached on a client device. In such a configuration, the client device can apply the rules to select content items to add to the content stream of a media station. This configuration can provide a number of advantages including decreasing the load on the server, minimizing bandwidth usage, minimizing battery usage, allowing for a wall between the service providing the media items and the service providing the invitational content items to increase user privacy, providing a more consistent presentation of the media, and enabling media station playback even under less than ideal network conditions.

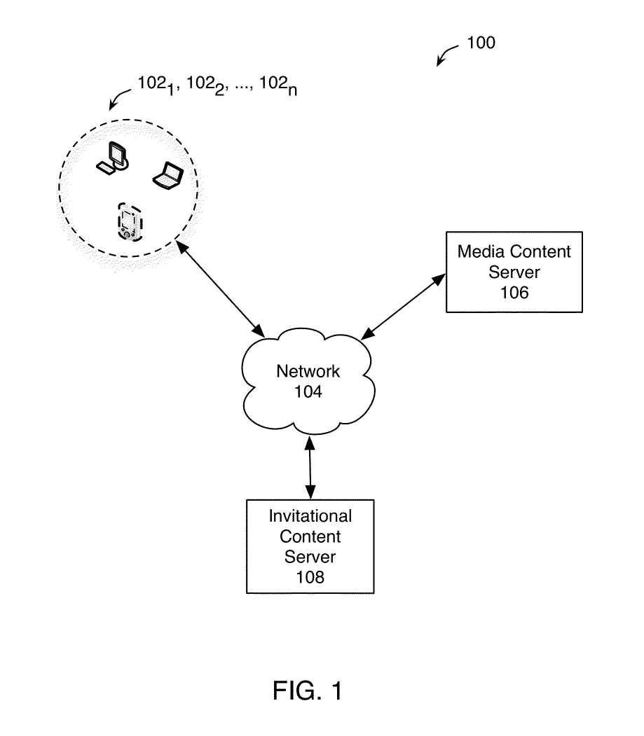

An exemplary system configuration 100 for generating a media station is illustrated in FIG. 1 wherein electronic devices communicate via a network for purposes of exchanging content and other data. The system can be configured for use on a local area network, such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, media items and/or invitational content can be delivered to client devices 102₁, 102₂, . . . , 102ₙ (collectively “102) connected to a network 104 by direct and/or indirect communications with a media content server 106 and/or an invitational content server 108. A client device 102 can be any network enabled computing device capable of receiving a media item, a list of candidate media items, an item of invitational content, a list of candidate invitational content items, and/or any rules necessary for generating a media station such as a desktop computer; a mobile computer; a handheld communications device, e.g. mobile phone, smart phone, tablet; a smart television; a set-top box; and/or any other network-enabled computing device. Furthermore, the media content server 106 and/or invitational content server 108 can concurrently accept connections from and interact with multiple client devices 102.

The manner in which a client device 102 can receive a media item can vary. In some cases, client device 102 can contain a physical media reading module, such as an optical disk reader. In this case, client device 102 can receive a media item via physical media. Alternatively, client device 102 can contain an interface for communicating directly with an external drive, such as a USB port, where an external hard drive or flash drive can be connected. Client device 102 can then receive a media item from the external drive. In some cases, client device 102 can receive a media item via a network connection. For example, a media item can be sent to client device 102 via network 104 from a content provider such as media server 106 or some other media provider. In another example, client device 102 can access an external storage connected to the client device via a network connection.

Although the media content server 106 and the invitational content server 108 are presented herein as separate entities, this is for illustrative purposes only. In some configurations, the media content and invitational content servers 106 and 108 can be the same entity. Thus, a single entity can define and provide the list of candidate media items, the list of candidate invitational content items, and any rules necessary to generate the media station. However, as indicated above, by maintaining separate servers, the system 100 is able to better maintain user privacy. Additionally, the system 100 can be configured with multiple media content servers and/or invitational content servers. For example, the system 100 can include media content servers for different types of media items, e.g. music, video, television shows, etc.

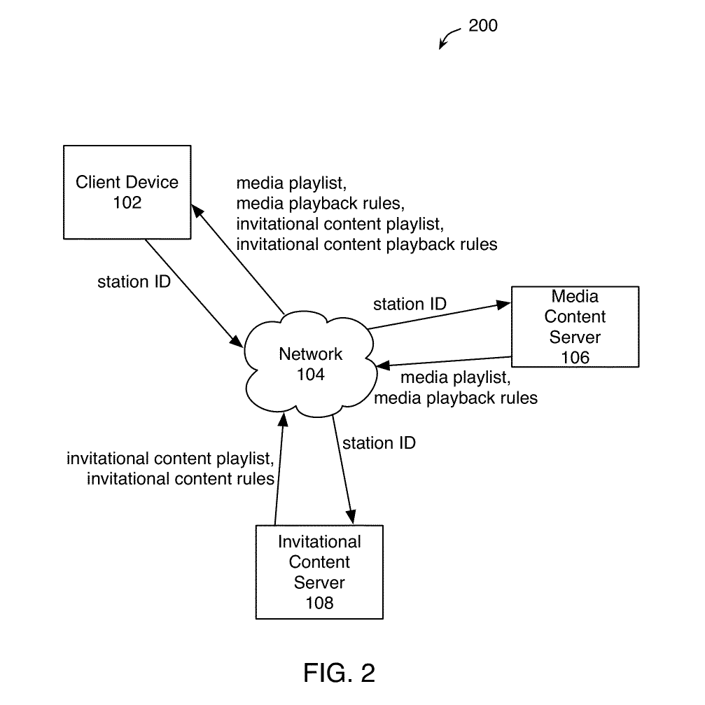

FIG. 2 illustrates an exemplary exchange of data 200 for the purpose of generating a media station on a client device. The media content server 106 can receive a request for a list of candidate media items, such as music, television shows, videos, etc., from one of client devices 102. The request can be specific to a media station and thus, as part of the request a client device can specify a station identifier. The media server 106 can use the station identifier to identify a previously defined media station. In some cases, a previously defined media station can be a curated station. That is, a station corresponding to a predefined collection of media items. For example, a curated station can be sponsored by a sporting goods company, and the sporting goods company can preselect a collection of media items that the sporting goods company has identified as exercise related media items, such as songs good for running. A previously defined media station can also be a user specific media station, such as a media station based on user characteristic values known about the user. Additionally, a previously defined media station can be a media station based on a seed item, such as a media item or artist. Additional methods of defining a media station are also possible.

In some cases, a media station can be defined just prior to initiating a media station. For example, a user can select a media item and then select a play station button. Upon clicking the button, a new station can be created and a station identifier can be assigned to the station. In some configurations, the media content server 106 can assign the station identifier and distribute the station identifier to the client device 102 and/or the invitational content server 108. Additionally, metadata associated with the station can be distributed. Alternatively, the system 100 can include an independent media station generation server, which can be responsible for establishing new stations, and distributing the pertinent information, such as station identifier, station metadata, and/or station specific rules to the relevant parties. A previously defined media station can also be an established media station, such as a curated or sponsored station, or a station based on a genre or a media item producer. In this case, upon selecting a play station button, the station identifier can be obtained.

In response to receiving the request for a list of candidate media items, the media server 106 can select a list of candidate media items and send the list to the requesting client device 102. The number of items specified in the list of candidate media items can vary with the configuration of the system, the rules associated with the station, the client device type, the bandwidth available, the media item type, and/or user preference. For example, the system 100 can be configured to default to a specific number of items or a number of items based on total playback time. The number of items or a number of items based on total playback time. The number of items can then be adjusted up or down based on the storage capacity of the requesting device. The number of items can also be adjusted based on the current network connection. For example, the number of items could be increased when connected over a broadband connection and decreased when connected over a cellular connection. Additionally, a user could specify a maximum allowable storage space on the client device or a user could request additional caching when the user knows network connectivity will be lost, such as when boarding a plane.

The list of candidate media items can specify a media item identifier for each candidate media item and metadata describing the media item. Furthermore, in some cases, the list can include a reference to a storage location for the media item. If the media item already exists in the user's media library the reference can be to a location in the user's media library. In some cases, the user's media library may reside on the client device. Alternatively, all or part of the user's media library can reside on a different, but accessible device. In some configurations, the reference can be to a media item residing in an external storage. However, the system can also be configured to limit references to locally available media items. In some cases, such a restriction can be a user specified preference. A system configured to use media items that already exist in the user's media library can provide further advantages in that it decreases the bandwidth usage and the amount storage used by the media station on the client device.

If the media item is not available in the user's media library, or if the system is configured such that it does not have knowledge of the user's media library, the media item can be downloaded to the client device and cached for playback or streamed to the client device. In some cases, the media item can be part of the list, and thus the reference is the actual media item. Alternatively, a separate storage location can be allocated for caching the media items specified in the list of candidate media items. In this case, a reference can point to a location in the allocated storage location.

In some cases, the client device 102 can request the list of candidate media items from the media content server 106 in response to an initial generation of a media station. For example, when starting a media station player or when switching from a first media station to a second media station. Additionally, the client device 102 can request a list of candidate media items when a number of media items remaining in the cached list of candidate media items falls below a predefined threshold value. For example, the initial list of candidate media items may include ten media items, with a minimum size threshold of five unused media items. In some configurations, a media item specified in the list of candidate media items can be considered used when it has been evaluated for playback eligibility. However, in other configurations, a media item can be considered used only when it has been deemed eligible for playback. Therefore, any media item evaluated to be currently ineligible at a time of testing could be retried at a later time. In some cases, a media item can be discarded from the list of candidate media items after evaluating the item for eligibility a predefined number of times. Once the predefined threshold has been reached additional candidate media items can be added to the list to replace the used media items. In some cases, the predefined threshold can vary with the configuration of the system, the client device type, the available bandwidth, the media item type, and/or user preference.

The client device 102 can also be configured to request an update after a specified period of time. For example, if a media stream has been paused for a significant period, upon playback resumption the client device can request an update or refresh. In another example, if the client device has been disconnected from the network for a predefined period of time, upon reconnecting the client device can request an update or refresh.

In addition to the list of candidate media items, the media server 106 can send one or more media playback rules. In some cases, one or more media playback rules sent to the client device 102 can be station specific, such as rules established by a station sponsor. Additionally, one or more rules sent to the client device 102 can be station independent, such as rules based on legal regulations or licensing agreements. The rules can be cached on the client device 102 and used by the client device 102 to identify a next media item eligible for playback from the list of candidate media items. Further details regarding how a client device uses the one or more media playback rules will be discussed below.

How often and/or with which requests the media content server 106 sends one or more media playback rules can vary with the configuration and/or the media playback rules already cached on a client device 102. In some cases, a media content server 106 can send all relevant media playback rules regardless of whether or not a client device 102 already contains a rule. Alternatively, the media content server 106 can be configured to only send the media playback rules that the client device 102 is missing or that are expired. In some cases, a media content server 106 can send the full set of media playback rules relevant to the station upon station initiation and then provide necessary updates when a client device requests an update to the list of candidate media items or when a client device 102 specifically requests an update to the media playback rules, such as at periodic intervals.

Additionally, the media content server 106 can be configured to push new or updated media playback rules to a client device 102. For example, if a legal regulation or licensing agreement changes, one or more media playback rules may also change. In this case, the change may require the new playback rules to be distributed to a client device even though the client device has not requested an update. In another example, a station sponsor may change one or more playback rules associated with the station.

In some embodiments, client device 102 can send additional information, such as a user identifier, to the media content server 106. The additional information can be sent as part of a request for content from the media content server or in a separate communication with the media content server 106. In some cases, the user identifier can be specific to the media content server 106. For example, the media content server 106 can maintain a user profile and the media content server 106 can use the user profile in selecting the media items for the list of candidate media items. For example, the media content server 106 can use the user profile information in conjunction with a media playlist generation rule that is based on user characteristics or demographic data to better customize the list of candidate media items for the user.

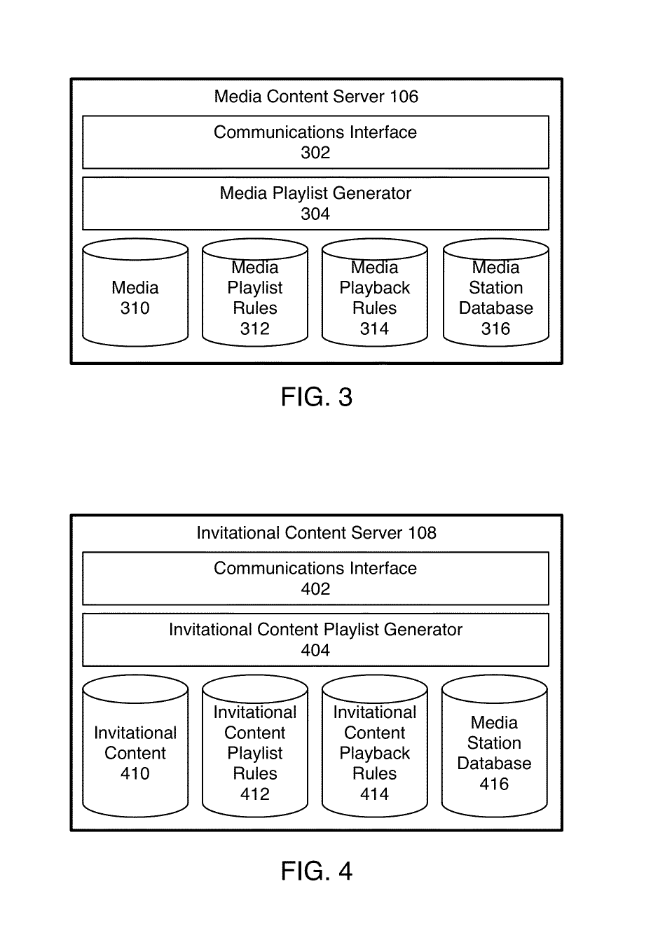

FIG. 3 illustrates an exemplary configuration of a media content server 106. The media content server 106 can contain a number of components. The components can include one or more databases for storing data relevant to the operation of the system, e.g. a media database 310, a media playlist rules database 312, a media playback rules database 314, and a media station database 316, and one or more modules for interacting with the databases and/or controlling the features provided by the media content server 106, e.g. a communications interface 302 and a media playlist generator 304. Each of the components in FIG. 3 is discussed in more detail below; however, it should be understood by one skilled in the art, that the architectural configuration illustrated in FIG. 3 is simply one possible configuration and that other configurations with more or less components is also possible.

The media content server 106 can maintain a number of assets and/or data, such as the one or more databases of information. In the exemplary configuration in FIG. 3, the media content server 106 maintains four databases. However, it should be understood by one skilled in the art that the media content server 106 can be configured with more or less databases. For example, the media content server 106 can be configured with multiple media databases, such as separate databases for different media item types, or separate databases for station specific and station independent rules.

The media content server 106 can include media items, e.g. music, videos, television shows, articles, books, etc. The media database 310 can be populated with the various media items. Additionally, each media item in the media database 310 can have associated metadata that can describe the media item and a unique media item identifier. In some configurations, the media database 310 can be the primary source of content for a media station. However, in some cases, the content for a media station can be augmented with content in a user's personal media library.

The media content server 106 can also include one or more media playlist generation rules for identifying candidate media items for a media station. The media playlist rules database 312 can be populated with various media playlist generation rules. In some cases, a media playlist generation rule can be specific to one or more media stations. Such media playlist generation rules can be associated with the one or more media station identifiers in the media playlist rules database 312. The media playlist generation rules can be expressed using a variety of formats and/or file types. For example, a media playlist generation rule can be expressed using XML, or some other mark-up language. In another example, a media playlist generation rule can be expressed using computer executable instructions, such as javascript.

The media content server 106 can also include one or more media playback rules that can be used to determine whether a candidate media item is currently eligible for playback. The media playback rules database 314 can be populated with the various media playback rules. In some cases, a media playback rule can be specific to one or more media stations. Such media playback rules can be associated with the one or more media station identifiers in the media playback rules database 314. The media playback rules can be expressed using a variety of formats and/or file types. For example, a media playback rule can be expressed using XML, or some other mark-up language. In another example, a media playback rule can be expressed using computer executable instructions, such as javascript.

The media content server 106 can also include information regarding one or more previously defined media stations. The media station database 316 can be populated with the media station information. Each media station can be assigned a unique station identifier, which can be stored in the media station database 316. Additionally, each media station in the media station database 316 can have associated metadata that can describe the media station.

In some configurations, the media content server 106 can include additional databases, such as a user profile or user account database. A user profile database can include user characteristic data known about the user such as user identifier, purchase and/or play history, account information, age, gender, occupation, etc. The user profile information can be used to aid in selecting candidate media items for a media station.

The media content server 106 can include a communications interface 302. The communications interface 302 can be configured to receive requests from one or more client devices 102. The requests can include a request for a new or updated list of candidate media items and/or a request for new or updated media playback rules. The communications interface 302 can also be configured to send data to a requesting one or more client devices 102. The sent data can be one or more media items, a new or updated list of candidate media items, and/or new or updated media playback rules.

The media content server 106 can also include a media playlist generator 304. The media playlist generator 304 can be configured to generate a list of candidate media items in response to a request from a client device 102. To generate a list of candidate media items, the media playlist generator 304 can apply one or more media playlist generation rules to the available media items, such as the media items in media database 310 and/or the media items known to be in the user's media library. The one or more media items applied can be based on the station. For example, all media rules associated with the media station identifier can be applied, as well as any media station independent rules, unless the station definition excludes media station independent rules.

Similar to the media content server 106, the invitational content server 108 in FIG. 2 can receive a request for a list of candidate invitational content items, such as advertisements, from one of client devices 102. The request can be specific to a media station and thus, as part of the request a client device can specify a station identifier. The invitational content server 108 can use the station identifier to identify a previously defined media station.

In response to receiving the request for a list of candidate invitational content items, the invitational content server 108 can select a list of candidate invitational content items and send the list to the requesting client device 102. Each candidate invitational content item can be associated with metadata that describes the invitational content item. The number of items specified in the list of candidate invitational content items can vary with the configuration of the system, the rules associated with the station, the client device type, the bandwidth available, the media type, the presentation type, and/or user preference. For example, the system 100 can be configured to default to a specific number of items. The number of items can then be adjusted up or down based on the storage capacity of the requesting device. The number of items can also be adjusted based on the current network connection. For example, the number of items could be increased when connected over a broadband connection and decreased when connected over a cellular connection. Additionally, a user could specify a maximum allowable storage space on the client device or a user could request additional caching when the user knows network connectivity will be lost, such as when boarding a plane. Alternatively, a user could specify a length of time the user would like to listen to the media station and the system could approximate a number of invitational content and/or media items required to fill the time period.

In some cases, the client device 102 can request the list of candidate invitational content items from the invitational content server 108 in response to an initial generation of a media station. For example, when starting a media station player or when switching from a first media station to a second media station. Additionally, the client device 102 can request a list of candidate invitational content items when a number of invitational content items remaining in the cached list of candidate invitational content items falls below a predefined threshold value. For example, the initial list of candidate invitational content items may include ten media items, with a minimum size threshold of five unused media items. In some configurations, an invitational content item specified in the list of candidate invitational content items can be considered used when it has been evaluated for playback eligibility. However, in other configurations, an invitational content item can be considered used only when it has been deemed eligible for playback. Therefore, any invitational content item evaluated to be currently ineligible at a time of testing could be retried at a later time. In some cases, an invitational content item can be discarded from the list of candidate invitational content items after evaluating the item for eligibility a predefined number of times. Once the predefined threshold has been reached additional candidate invitational content items can be added to the list to replace the used invitational content items. In some cases, the predefined threshold can vary with the configuration of the system, the client device type, the available bandwidth, the media item type, and/or user preference.

The client device 102 can also be configured to request an update after a specified period of time. For example, if a media stream has been paused for a significant period, upon playback resumption the client device can request an update or refresh. In another example, if the client device has been disconnected from the network for a predefined period of time, upon reconnecting the client device can request an update or refresh. In some cases, the refresh rate can be based on a prediction as to when new content will be needed by analyzing the user's usage history. The usage history can include a history of station identifiers, and therefore the client device 102 could predict when a user will change stations and/or what stations the user may play and content appropriate for the predicted station identifiers can be refreshed.

In addition to the list of candidate invitational content items, the media server 106 can send one or more invitational content playback rules. In some cases, one or more invitational content playback rules sent to the client device 102 can be station specific, such as rules established by a station sponsor. Additionally, one or more rules sent to the client device 102 can be station independent, such as rules based on legal regulations or licensing agreements. The rules can be cached on the client device 102 and used by the client device 102 to identify a next invitational content item eligible for playback from the list of candidate invitational content items. Further details regarding how a client device uses the one or more invitational content playback rules will be discussed below.

How often and/or with which requests the invitational content server 108 sends one or more invitational content playback rules can vary with the configuration and/or the invitational content playback rules already cached on a client device 102. In some cases, a invitational content server 108 can send all relevant invitational content playback rules regardless of whether or not a client device 102 already contains a rule. Alternatively, the invitational content server 108 can be configured to only send the invitational content playback rules that the client device 102 is missing or that are expired. In some cases, a invitational content server 108 can send the full set of invitational content playback rules relevant to the station upon station initiation and then provide necessary updates when a client device requests an update to the list of candidate invitational content items or when a client device 102 specifically requests an update to the invitational content playback rules, such as at periodic intervals.

Additionally, the invitational content server 108 can be configured to push new or updated invitational content playback rules to a client device 102. For example, a sponsorship agreement changes, one or more invitational content playback rules may also change. In this case, the change may require the new playback rules to be distributed to a client device even though the client device has not requested an update.

In some embodiments, client device 102 can send additional information, such as a user identifier, to the invitational content server 108. The additional information can be sent as part of a request for content from the invitational content server 108 or in a separate communication with the invitational content server 108. In some cases, the user identifier can be specific to the invitational content server 108. For example, the invitational content server 108 can maintain a user profile and the invitational content server 108 can use the user profile in selecting the invitational content items for the list of candidate invitational content items. For example, the invitational content server 108 can use the user profile information in conjunction with a invitational content playlist generation rule that is based on user characteristics or demographic data to better customize the list of candidate invitational content items for the user.

FIG. 4 illustrates an exemplary configuration of an invitational content server 108. The invitational content server 108 can contain a number of components. The components can include one or more databases for storing data relevant to the operation of the system, e.g. a invitational content database 410, a invitational content playlist rules database 412, a invitational content playback rules database 414, and a media station database 416, and one or more modules for interacting with the databases and/or controlling the features provided by the invitational content server 108, e.g. a communications interface 402 and an invitational content playlist generator 404. Each of the components in FIG. 4 is discussed in more detail below; however, it should be understood by one skilled in the art, that the architectural configuration illustrated in FIG. 4 is simply one possible configuration and that other configurations with more or less components is also possible.

The invitational content server 108 can maintain a number of assets and/or data, such as the one or more databases of information. In the exemplary configuration in FIG. 4, the invitational content server 108 maintains four databases. However, it should be understood by one skilled in the art that the invitational content server 108 can be configured with more or less databases. For example, the invitational content server 108 can be configured with multiple invitational content databases, such as separate databases for different invitational content item types, or separate databases for station specific and station independent rules.

The invitational content server 108 can include invitational content items, e.g. advertisements. The invitational content database 410 can be populated with the various invitational content items. Additionally, each invitational content item in the invitational content database 410 can have associated metadata that can describe the invitational content item and a unique invitational content item identifier.

The invitational content server 108 can also include one or more invitational content playlist generation rules for identifying candidate invitational content items for an invitational content station. The invitational content playlist generation rules database 412 can be populated with various invitational content playlist generation rules. In some cases, an invitational content playlist generation rule can be specific to one or more invitational content stations. Such invitational content playlist generation rules can be associated with the one or more media station identifiers in the invitational content playlist rules database 412. The invitational content playlist generation rules can be expressed using a variety of formats and/or file types. For example, an invitational content playlist generation rule can be expressed using XML, or some other mark-up language. In another example, a invitational content playlist generation rule can be expressed using computer executable instructions, such as javascript.

The invitational content server 108 can also include one or more invitational content playback rules that can be used to determine whether a candidate invitational content item is currently eligible for playback. The invitational content playback rules database 414 can be populated with the various invitational content playback rules. In some cases, an invitational content playback rule can be specific to one or more media stations. Such invitational content playback rules can be associated with the one or more media station identifiers in the invitational content playback rules database 414. The invitational content playback rules can be expressed using a variety of formats and/or file types. For example, an invitational content playback rule can be expressed using XML, or some other mark-up language. In another example, an invitational content playback rule can be expressed using computer executable instructions, such as javascript.

The invitational content server 108 can also include information regarding one or more previously defined media stations. The media station database 416 can be populated with the media station information. Each media station can be assigned a unique station identifier, which can be stored in the media station database 416. Additionally, each media station in the media station database 416 can have associated metadata that can describe the media station.

In some configurations, the invitational content server 108 can include additional databases, such as a user profile or user account database. A user profile database can include user characteristic data known about the user such as user identifier, demographic information, etc. The user profile information can be used to aid in selecting candidate invitational content items for a media station.

The invitational content server 106 can include a communications interface 402. The communications interface 402 can be configured to receive requests from one or more client devices 102. The requests can include a request for a new or updated list of candidate invitational content items and/or a request for new or updated invitational content playback rules. The communications interface 402 can also be configured to send data to a requesting one or more client devices 102. The sent data can be a new or updated list of invitational content items, which can include the actual invitational content items and/or new or updated invitational content playback rules. Each invitational content item distributed to a client device can have associated metadata describing the invitational content item.

The invitational content server 108 can also include an invitational content playlist generator 404. The invitational content playlist generator 404 can be configured to generate a list of candidate invitational content items in response to a request from a client device 102. To generate a list of candidate invitational content items, the invitational content playlist generator 404 can apply one or more invitational content playlist rules to the available media items. The one or more invitational content playlist rules applied can be based on the station. For example, all invitational content playlist generation rules associated with the media station identifier can be applied, as well as any media station independent rules, unless the station definition excludes media station independent rules.

The client device 102 in FIG. 2 can receive the requested data, which can include a list of candidate media items, a list of candidate invitational content items, one or more media playback rules, and/or one or more invitational content playback rules. The client device 102 can use the received data to generate a content stream for the media station.

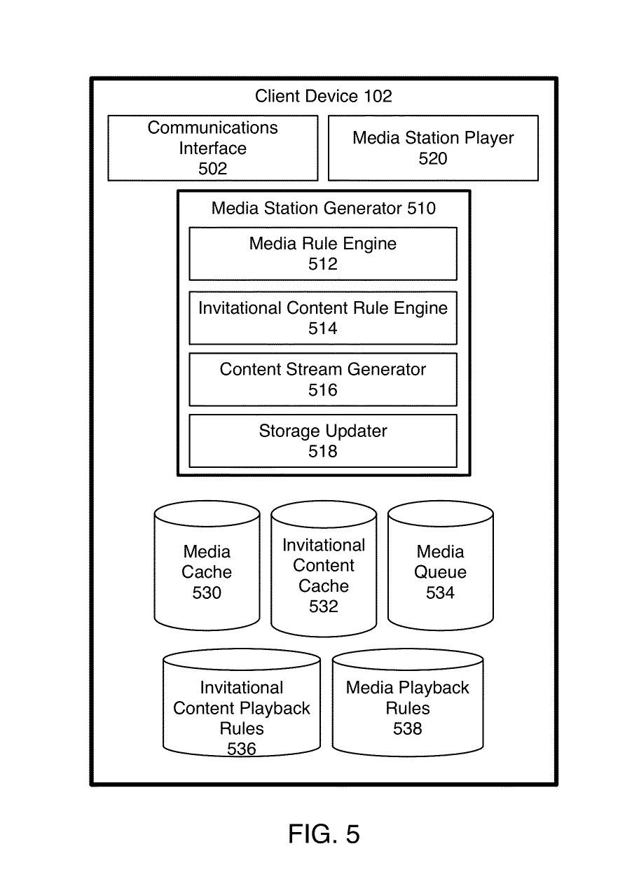

FIG. 5 illustrates an exemplary configuration of a client device 102. The client device 102 can include a number of components to aid in generating the media station. The components can include one or more databases or other storage structures for storing data relevant to the operation of the system, e.g. media cache 530, invitational content cache 532, media queue 534, invitational content playback rules database 536, and media playback rules 538, and one or more modules for interacting with the storage structures and/or controlling the features provided by the client device 102, e.g. communications interface 502, media station generator 510, media rule engine 512, invitational content rule engine 514, content stream generator 516, storage updater 518, and media station player 520. Each of the components in FIG. 5 is discussed in more detail below; however, it should be understood by one skilled in the art, that the architectural configuration illustrated in FIG. 5 is simply one possible configuration and that other configurations with more or less components are also possible.

The client device 102 can maintain a number of assets and/or data, such as the one or more storage structures of information. In the exemplary configuration in FIG. 5, the client device 102 maintains 5 storage structures. However, it should be understood by one skilled in the art that the client device 102 can be configured with more or less storage structures. The client device 102 can receive a list of candidate media items from which the client device 102 can select currently eligible media items for playback on the media station. The client device 102 can store the list of candidate media items in the media cache 530. The list of candidate media items can include a unique media item identifier and associated metadata for each media item in the list. Additionally, in some cases, the list of candidate media items can include one or more media items and/or references to a storage location of the one or more media items in the list of candidate media items. In some configurations, any media items used by the list of candidate media items can be stored along with the list in the media cache 530. However, in some cases, the media cache can contain fewer media items than specified in the list of candidate media items if one or more media items exist in the user's personal media library.

When and what data is erased from the media cache can vary with the configuration of the system. In some configurations, a media item can be removed from the media cache after playback has completed or once a media item has been determined to not be eligible for playback. As described above, the client device 102 can be configured to check the eligibility of a media item in the list of candidate media items one or more times prior designating the media item as unusable. However, in some cases, once a media item has been designated unusable, the media item can be removed from the media cache 530. In some configurations, all downloaded media items can remain in the media cache 530 until the client device 102 receives a new list of candidate media items. Additionally, the termination of a media station can cause the client device 102 to erase the cached media items and/or the list of candidate media items. Additionally, the client device 102 can be configured to remove data from the media cache 530 after a predefined period of inactivity.

The media cache 530 can also be configured to cache data relevant to multiple media stations. In this configuration, when switching from a first media station to a second media station, the client device 102 can maintain the cached data from the first media station. This can be advantageous in that it can allow a user to switch between media stations without requiring a refresh of the content. For example, a user could elect to initiate multiple media streams for use in an offline configuration. In another example, a user could start a new media station, but quickly decide that the pervious stream was more enjoyable and switch back. In some cases, a maximum number of media stations can be set. Once the maximum has been reached the client device 102 can remove data associated with a media station, such as the media station that has not been used for the longest period of time. Additionally, the client device 102 can be configured to remove data associated with a media station after a predefined period of inactivity.

The client device 102 can receive a list of candidate invitational content items from which the client device 102 can select currently eligible invitational content items for playback on the media station. The client device 102 can store the list of candidate invitational contents items in the invitational content cache 532. The list of candidate invitational content items can include a unique invitational content item identifier, an invitational content item, and/or associated metadata for each invitational content item in the list.

When and what data is erased from the invitational content cache 532 can vary with the configuration of the system and/or the type of invitational content. The system can be configured to support multiple classes of invitational content. A class of invitational content can be one or limited use invitational content. That is, an item of invitational content can have an associated maximum use count. Once the item of invitational content has been played the maximum number of times it can be designated unusable. Another class of invitational content can be time based. That is, an item of invitational content can have an associated expiration value, such as a date or time period. Once the expiration value has been reached, the invitational content item can be designated unusable.

In some configurations, an invitational content item can be removed from the invitational content cache 532 after playback has completed or once an invitational content item has been determined to be unusable. As described above, the client device 102 can be configured to check the eligibility of an invitational content item in the list of candidate invitational content items one or more times prior designating the media item as unusable. However, in some cases, once an invitational content item has been designated unusable, the invitational content item can be removed from the invitational content cache 532. In some configurations, all downloaded invitational content items can remain in the invitational content cache 532 until the client device 102 receives a new list of candidate invitational content items. Additionally, the termination of an invitational content station can cause the client device 102 to erase the cached invitational content items and/or the list of candidate invitational content items. In some cases, the client device 102 can be configured to remove data from the invitational content cache 532 after a predefined period of inactivity or upon expiration of the invitational content item.

The invitational content cache 532 can also be configured to cache data relevant to multiple media stations. In this configuration, when switching from a first media station to a second media station, the client device 102 can maintain the cached data from the first media station. This can be advantageous in that it can allow a user to switch between media stations without requiring a refresh of the content. In some cases, a maximum number of media stations can be set. Once the maximum has been reached the client device 102 can remove data associated with a media station, such as the media station that has not been used for the longest period of time. Additionally, the client device 102 can be configured to remove data associated with a media station after a predefined period of inactivity.

The client device 102 can also include a media queue 534. The client device 102 can add a media item to the media queue 534 upon determining that the media item is currently eligible for playback. When a next media item is needed for the content stream, the next un-played media item in the media queue 534 can be used. Additionally, the media queue can serve as a play history. That is, media item identifiers can be added to the media queue 534 in the order that the media items are played. After a media item is played, the media item identifier can remain in the media queue 534, but can be marked as played. The ordered list of played media item identifiers can then represented the play history. The media queue 534 can also be configured to store data regarding the playback history of the invitational content items.

In some cases, the client device 102 can maintain a single list in the media queue 534 that can be used across multiple media stations. In this case, upon a switch between a first media station and a second media station, any un-played items in the play queue can be removed so that they are not played on the second media station. Alternatively, the client device 102 can maintain multiple lists, each corresponding to a media station.

How long data can remain in the media queue 534 can vary with the configuration and/or the existing playback rules. As described above, some media and invitational content rules can require historical data, such as the play history. Therefore, in some cases, data in the media queue 534 can be kept for as long as is required in order to properly apply the playback rules.

The client device 102 can also receive one or more invitational content playback rules, which can be stored in the invitational content playback rules database 536, and/or one or more media playback rules, which can be stored in the media playback rules database 538. The client device 102 can use the various rules to determine which media items and/or invitational content items to play on the media station. In some cases, a playback rule can be specific to one or more media stations. Such playback rules can be associated with the one or more media station identifiers in the rules databases.

In some cases, a rules database can be configured to maintain playback rules for a single media station. In this case, upon switching to a new media station, the playback rules can be replaced. Alternatively, a rules database can be configured to maintain playback rules for multiple media stations. In this case, playback rules can be removed and/or updated as needed. For example, if there is insufficient space to store the rules for a currently active media station, the rules associated with an old media station can be replaced. In another example, if a playback rule has been updated, such as a rule based on a licensing agreement, the playback rule in a rules database can be updated.

The client device 102 can include a communications interface 502. The communications interface 502 can be configured to send requests to the media content server 106 and/or the invitational content server 108. The requests can include a request for a new or updated list of candidate media items and/or a request for a new or updated list of candidate invitational content items. The communications interface 502 can also be configured to receive data from the media content server 106 and/or the invitational content server 108. The received data can include one or more media items, a new or updated list of candidate media items, a new or updated list of candidate invitational content items, new or updated media playback rules, and/or new or updated invitational content rules.

The client device 102 can also include a media station generator 510. The media station generator 510 can include one or more modules, e.g. a media rule engine 512, an invitational content rule engine 514, a content stream generator 516, and a storage updater 518, for processing the list of candidate media items and the list of candidate invitational content items to generate a stream of content for the media station.

The media rule engine 512 can be configured to select a next media item from the list of candidate media items in the media cache 530 and determine whether it is currently eligible for playback. To determine eligibility, the media rule engine 512 can apply one or more media playback rules from the media playback rule database 538. If a media item is eligible, the media rules engine 512 can add the media item to the media queue 534. Furthermore, in some cases, the media rules engine 512 can mark the media as used in the list of candidate media items. If the media item is not currently eligible, the media rules engine 512 can mark the media item identifier in the list of candidate media items as ineligible or unusable. In some cases, the media rules engine 512 can be configured to check a media item multiple times for eligibility when previous checks returned ineligible. After a predetermined number of verifications, the media rules engine 512 can mark a media item as unusable.

The invitational content rule engine 514 can be configured to apply one or more invitational content playback rules from the invitational content rules database 536 to the list of candidate invitational content items in the invitational content cache 532 to identify invitational content that is currently eligible for playback. In some cases, the invitational content rule engine 514 can identify more than one invitational content item that are currently eligible for playback. In the event that only a single invitational content item is required at the particular time, a best-fit invitational content item can be selected. For example, a playback rule associated with the station may indicate an invitational content item preference. In another example, metadata associated with the invitational content items and the media station and/or current media items can be matched.

If an invitational content item is eligible for playback, the invitational content item can be added to the content stream for the media station. Furthermore, in some cases, the invitational content rule engine 514 can mark the invitational content item as used or increment an associated use counter. In some cases, the invitational content rule engine 514 can be configured to check an invitational content item multiple times for eligibility when previous checks returned ineligible. After a predetermined number of verifications, the invitational content rule engine 514 can mark an invitational content item as unusable.

In some configurations, the invitational content rule engine 514 can be activated in response to an invitational content triggering event or action. Invitational content triggering events can include launching a media station player; initiating a new media station; completing playback of a media item; activating a predefined user interface feature, e.g. a particular screen of the user interface; moving the device in a predefined manner, e.g. detecting movement using an accelerometer or other sensor in the client device; moving the device within a predefined distance of a predefined sensor, e.g. a proximity sensor; and/or some other user action, such as pausing for a predetermined period of time or skipping a media item. Additionally, the invitational content triggering action can be a factor in selecting a presentation method. For example, if the trigger is initiation of a new media station, the presentation method can be an invitational content item that prevents the playback of a next media item. In another example, if the trigger is pausing for a predetermined period of time, the presentation method can be to display a banner ad that disappears when the user resumes play.

The content stream generator 516 can be configured to communicate with the media rule engine 512 and/or the invitational content rule engine 514 to identify next media items and/or invitational content items to add to a content stream associated with the media stream. In some cases, the content stream generator 516 can request a next item from the media rule engine 512 at various times. For example, the content stream generator 516 can request a next media item in response to an initiation of a new media stream. In another example, the content stream generator 516 can request a next media item in response to playback of the current content item reaching a predefined point in the playback, such five seconds from the end. In some cases, the predefined point can vary with the configuration of the system, the type of media item currently playing, the size of the cache, etc. In a further example, the content stream generator 516 can request a next media item in response to a user action, such as a content item skip. In some cases, the content stream generator 516 can queue up multiple items in the content stream

The storage updater 518 can be configured to update one or more of the storage structures on the client device. For example, in some configurations, a user can like and/or ban media items. In response to a like or ban user action, the client device 102 can create a new playlist and/or playback rule, or update the user's preferences. The storage updater 518 can update a rules database to include the new rule. Additionally, if a new playlist generation rule is created, the new playlist generation rule can be communicated to the appropriate content server. Alternatively, the storage updater 518 can send the like or ban preference to the appropriate content server. In response to the like or ban preference, the content server can regenerate the playlist based on the new data.

The storage updater 518 can also be configured to update the various caches to add, update, and/or remove content. For example, the storage updater 518 can be configured to periodically check the invitational content queue to determine if any invitational content has expired, and if so to remove it from the cache. In another example, the storage updater 518 can be configured to clear the various caches in response to a change from a first media station to a second media station. In some embodiments, the storage updater 518 can update the various caches to remove and/or filter content based on parental controls. For example, the storage updater 518 can filter content to prevent the playback of media items with an explicit rating.

Finally, the client device 102 can include a media station player 520 that can playback the media items and/or invitational content items added to the content stream. The media station player 520 can fetch the next content item from the content stream when a next item is required for playback. The media station player 520 can include functionality such as pausing, skipping, liking, banning, initiate new media station, etc.

In the various embodiments, the one or more databases described herein can be implemented using any type of data structures. Such data structures include but are not limited to, data structures for relational databases, key/value stores, graph databases, hierarchical databases, and distributed or columnar stores. According, although the various embodiments described herein may refer to specific data structures, in other embodiments such data structures can be substituted for any other data structures.

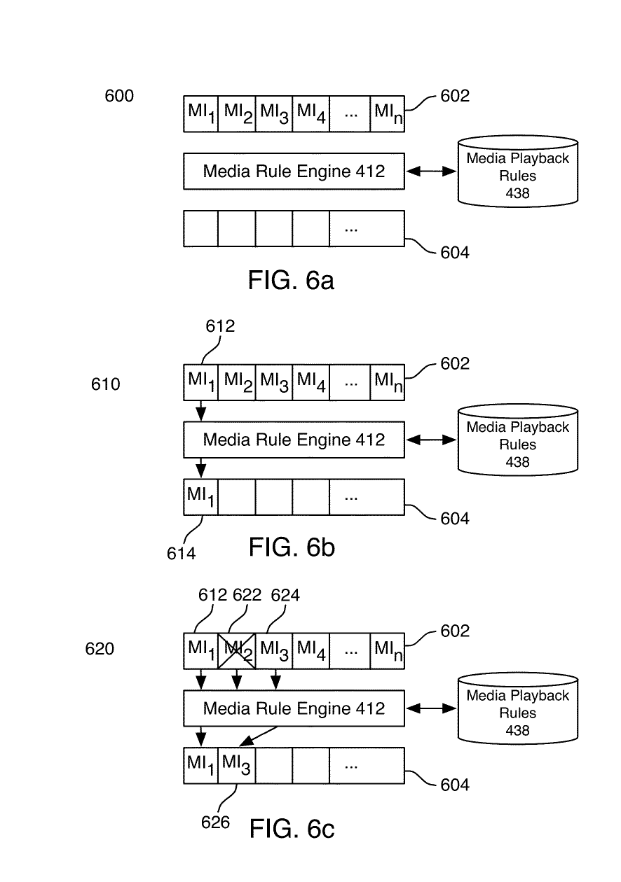

FIGS. 6a-6b illustrate an exemplary scenario of selecting media items to add to a media queue for playback on a media station. FIG. 6a illustrates an exemplary initial set-up 600 of a candidate media playlist and media queue for the media station. In the initial set-up, a list of candidate media items 602 contains multiple identifiers of media items that are candidates for playback on the media station. Since the list of candidate media items 602 represents an initial set-up, all items in the list 602 are still viable candidates. Additionally, since no items have been determined to be currently eligible for playback, the media queue 604 is empty. As noted, in some cases, a media queue can contain data from a previously active media station.

FIG. 6b illustrates an exemplary scenario 610 of identifying a first media item eligible for playback. To identify a first media item, the media rule engine 412 selects the first item 612 from the list of candidate media items 602 and applies one or more media playback rules from the media playback rules database 538 to the media item 612. The result of the application of the one or more rules can be an eligibility value. In scenario 610, the media item 612 is determined to be currently eligible for playback. Therefore, the media item 612 is added to the media queue 604 at slot 614.

FIG. 6c illustrates an exemplary scenario 620 of identifying a next media item eligible for playback. To identify a next media item, the media rule engine 412 selects the second item 622 from the list of candidate media items 602 and applies one or more media playback rules from the media playback rules database 538 to the media item 622. In some cases, the media rule engine 412 can use playback historical data in addition to the one or more media playback rules to determine whether a media item is currently eligible for playback. In scenario 620, very little historical data is known because only a single media item has been selected for playback.

In scenario 620, the result of the application of the one or more rules is a determination that media item 622 is not currently eligible for playback; therefore media item 622 is marked as ineligible, as indicated here by the “X.” A factor in the ineligible result could be the previously selected media item. For example, if a media playback rule specifies that two items from a single album cannot be played back to back and media items 612 and 622 are from the same album, then media item 622 would be ineligible for playback after media item 612. However, if the system is configured to re-check a media, then media item 622 could become eligible at a later time. Additionally, in some cases, the outcome of the application of a media playback rule can be influenced by one or more user actions. For example, for a time based media playback rule, in the presence of a user pause action, the timing of the rule application can alter the determined eligibility of a particular media item. That is, if the rule is applied at the beginning of a pause, and a media item is determined not to be currently eligible for playback, but the pause continues for one-hour, the media item could be determined to be eligible, if the rule were to be applied at the end of the pause. Therefore, it can be preferred to delay determining the eligibility of the media items until a next media is actually needed. That is, it can be preferable to maintain a fewer number of un-played media items in a media queue and/or content stream.

Since media item 622 is currently ineligible, and a next media item is still needed, the media rule engine 412 can select the next media item 624 in the list of candidate media items 602. The media rule engine 412 can apply the same one or more media playback rules to the media item 624. In scenario 620, the result of the application of the one or more rules is a determination that media item 624 is currently eligible for playback; therefore media item 624 is added to the media queue 604 at slot 626.

In some cases, the list of candidate media items can be an ordered list, and therefore the media rule engine 412 can sequential check eligibility of the media items in the list. However, the list of candidate media items can also be an unordered collection or a list in which order is not important. Furthermore, regardless of whether the list of candidate media items is an order list or not, the media rule engine 412 can be configured to select media items from the list in a manner other than traversing the list one by one, such as in a random order or an order based on some other criteria.

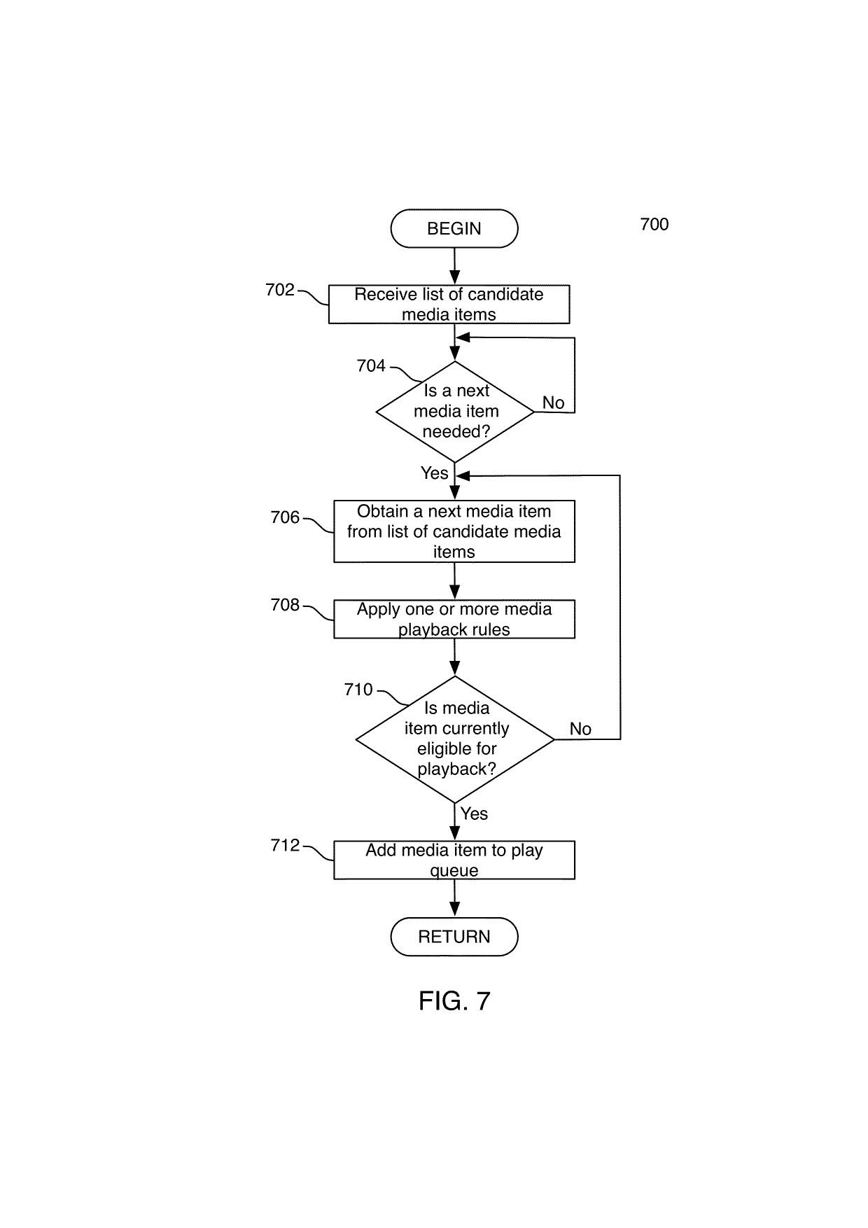

FIG. 7 is a flowchart illustrating steps in an exemplary method 700 for identifying a next media item for playback. For the sake of clarity, this method is discussed in terms of an exemplary client device 102 in FIG. 5. Although specific steps are shown in FIG. 7, in other embodiments a method can have more or less steps than show.

The client device 102 can receive a list of candidate media items (702), such as from a media server 106. The list of candidate media items can specify media item identifiers for one or more media items that are candidates for playback on a media station. Additionally, each media item identifier can be associated with metadata describing the media item. Furthermore, each media item identifier can be associated with a reference to a storage location for the media item. In some cases, the reference can be to a media item in the user's personal media library stored on the client device 102 or on a device accessible to the client device 102. Alternatively, the reference can be to a media item downloaded to the client device for the purpose of playback on the media station.

After receiving the list of candidate media items, the client device 102 can check if a next media item is needed in the content stream (704). A need for a next media item can occur at various times, such as in response to an initiation of a new media stream, playback of a current item reaching a predefined point in the playback, and/or a user action, e.g. a media item skip. If a next media item is needed, the client device can obtain a next media item identifier from the list of candidate media items (706) and apply one or more media playback rules to the media item identifier (708).

The result of applying the one or more media playback rules can be a current eligibility value. The client device 102 can then check if the current eligibility value is eligible (710). If the media item is currently eligible for playback, the client device can add the media item to the media queue (712) and the content stream for the media station. If the media item is currently ineligible for playback, the client device can make note of the ineligibility and repeat the eligibility check with a next media item. In some cases, marking a media item as ineligible can be a temporary designation and the client device 102 can check the media item again at a later time. For example, the client device 102 can be configured to loop through the list of candidate media items multiple times. In this case, the client device 102 can re-check the media item when the media item is encounter on s subsequent loop through the list. In another example, the client device 102 can be configured to re-check a media item when a subsequent media item is needed for the media station. Furthermore, the client device 102 can be configured with a maximum eligibility check value. In this case, when a media item has been check for current eligibility the maximum number of times, the media item can then be marked unusable and it the client device 102 will not check the media item again in that list of candidate media items. After identifying a media item for playback on the media station, the client device 102 can resume previous processing, which can include repeating method 700.

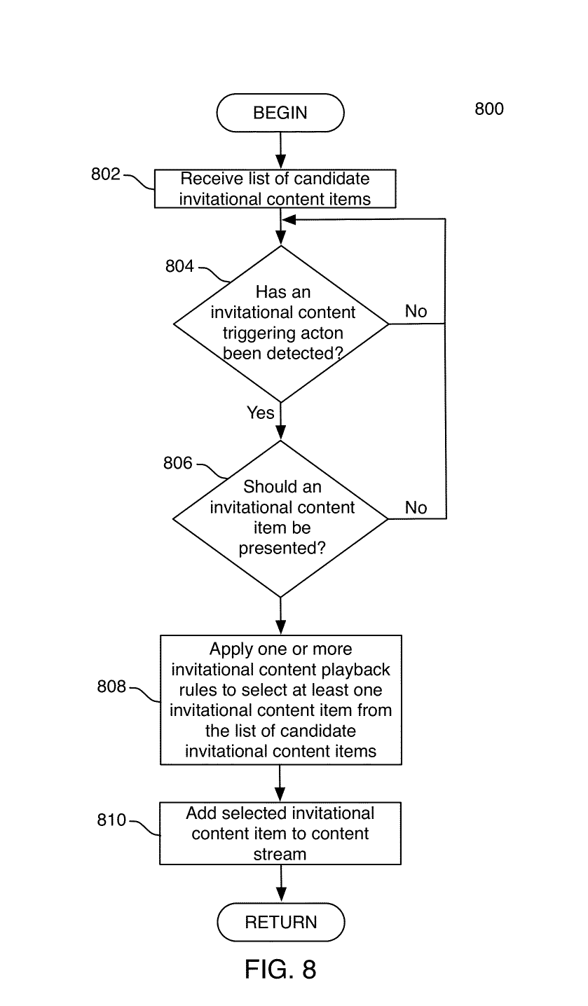

FIG. 8 is a flowchart illustrating steps in a first exemplary method 800 for identifying a next invitational content item for playback on a media station. For the sake of clarity, this method is discussed in terms of an exemplary client device 102 in FIG. 5. Although specific steps are shown in FIG. 8, in other embodiments a method can have more or less steps than show.

The client device 102 can receive a list of candidate invitational content items (802), such as from an invitational content server 108. The list of candidate invitational content items can specify an identifier for one or more invitational content items that are candidates for playback on a media station. Additionally, each invitational content item identifier can be associated with metadata describing the invitational content item. Furthermore, each media item identifier can be associated with a reference to a storage location the invitational content item cached on the client device 102. In some cases, the list can be an update or a refresh of the list of candidate invitational content items.

At some point during the playback of the media station, the client device 102 can check if an invitational content triggering action has occurred (804). An invitational content triggering action can occur at various times, such as initiation of a new media station, completion of a media item, and/or a user action, such as pausing for a predetermined period of time or skipping a media item. If an invitational content triggering event has been detected, the client device 102 can apply one or more invitational content playback rules to determine whether an invitational content item should be presented (806). For example, an invitational content rule can be applied to determine whether sufficient time has passed since a first invitational content item has been presented. If it is determined that an invitational content item should not be presented at the current time, the client device can wait for the detection of a next triggering event. However, if an invitational content item should be presented, the client device can select at least one invitational content item from the list of candidate invitational content items, such as by applying one or more invitational content playback rules to the list of candidate invitational content items (808), and add it to the content stream (810). In some cases, the client device 102 can identify more than one invitational content item that is currently eligible for playback. In the event that only a single invitational content item is required at the particular time, a best-fit invitational content item can be selected.

The client device can add the one or more selected invitational content items to the content stream (810), where the media stream player can retrieve it and present it on the media station. In some cases, when a user switches to a new media station, the device 102 can flush the content stream. After adding the selected invitational content to the content stream for playback on the media station, the client device 102 can resume previous processing, which can include repeating method 800.

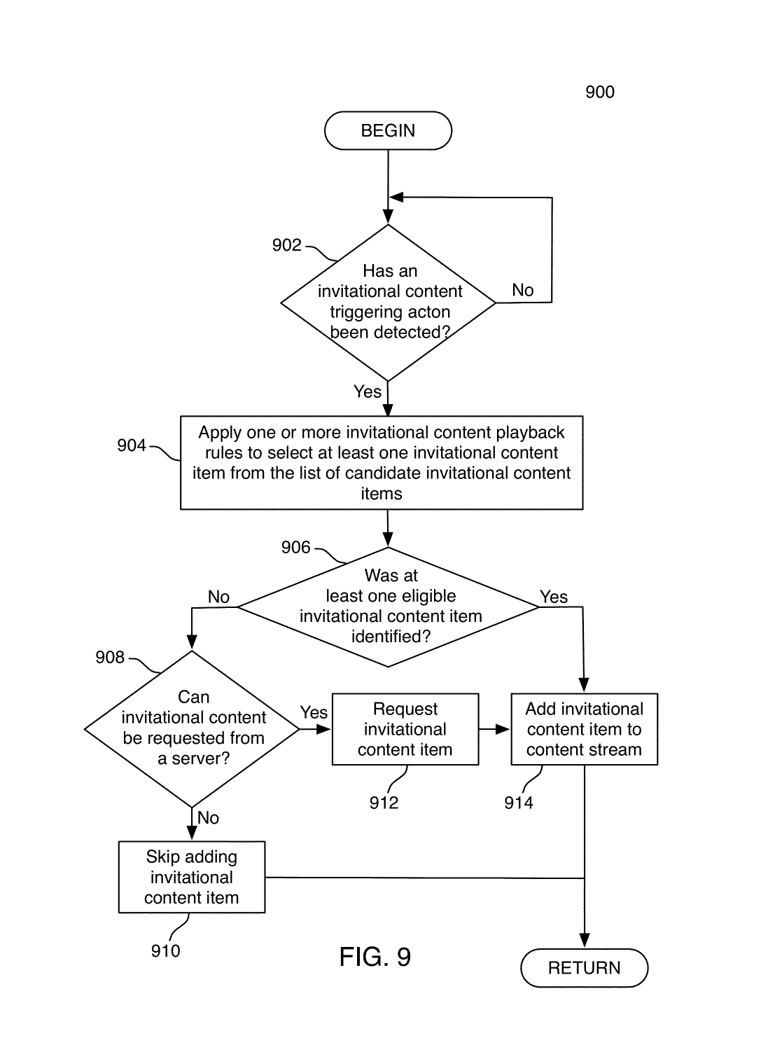

FIG. 9 is a flowchart illustrating steps in a second exemplary method 900 for identifying a next invitational content item for playback on a media station. For the sake of clarity, this method is discussed in terms of an exemplary client device 102 in FIG. 5. Although specific steps are shown in FIG. 9, in other embodiments a method can have more or less steps than show.

At some point during the playback of the media station, the client device 102 can check if an invitational content triggering action has occurred (902), such as initiation of a new media station, completion of a media item, and/or a user action, such as pausing for a predetermined period of time or skipping a media item. If an invitational content triggering event has been detected, the client device 102 can apply one or more invitational content playback rules to the list of candidate invitational content items (904).

After applying the one or more invitational content playback rules, the client device 102 can check if at least one locally cached invitational content item is currently eligible for playback (906). If an invitational content item was identified it can be added to the content stream for the media station (914). Otherwise, the client device 102 can check if invitational content can be requested from the server (908). For example, if the client device 102 is currently offline or if the client device 102 does not have sufficient bandwidth to download an item of invitational content, then the client device 102 cannot request invitational content from the server. If the client device can request invitational content, then the content is requested (912) and added to the content stream for the media station (914). Otherwise, if the client device 102 cannot request invitational content, the client device skips adding invitational content to the content stream (910). After either skipping adding invitational content to the content stream or adding it, the client device 102 can resume previous processing, which can include repeating method 900.

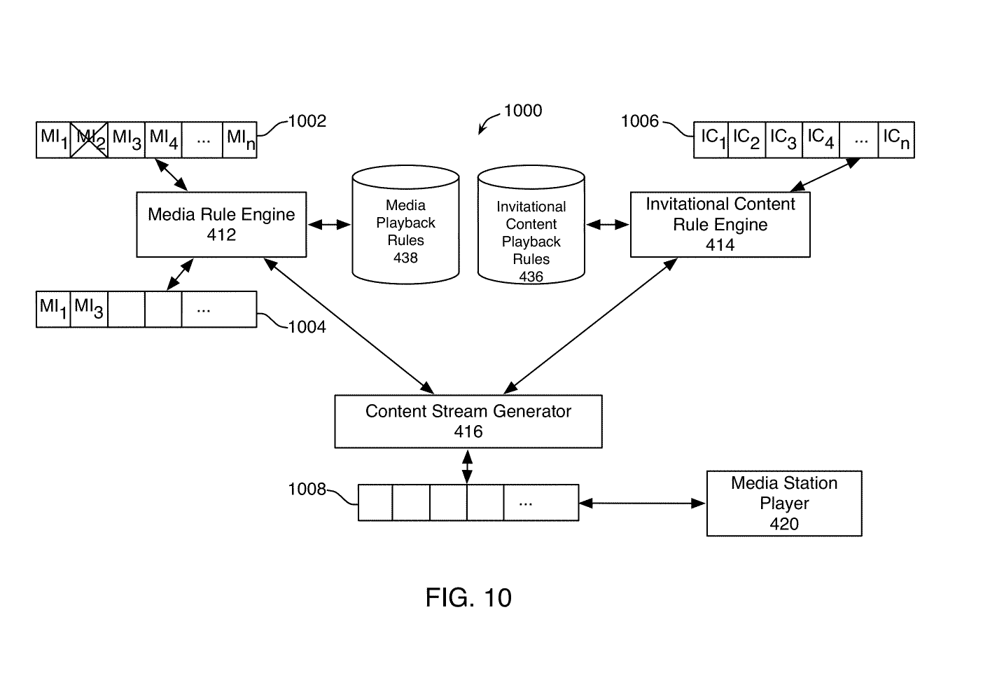

FIG. 10 illustrates an exemplary overview of a media station generation on a client device, such as client device 102. The media station player can fetch content to play from the content stream 1008. The content stream generator 416 can maintain the content stream 1008. When the content stream generator 416 determines that an additional media item is needed for the content stream, the content stream generator 416 can request a media item from the media rule engine 412.

In response to the request from the content stream generator 416, the media rule engine 412 can obtain one or more media playback rules applicable to the media station from the media playback rules database 438. The media rule engine 412 can then identify a media item identifier from the list of candidate media items 1002 by applying the one or more obtained media playback rules to the list 1002. When the media rule engine 412 determines a currently eligible media item identifier, the media rule engine 412 can obtain the corresponding media item and send the media item to the content stream generator 416. In some cases, the media rule engine 412 can obtain the currently eligible media item from a local cache of media items downloaded for playback on the media station. However, the media rule engine 412 can also obtain the currently eligible media item from a user's personal media library. Additionally, the media rule engine 412 can add the media item identifier to the play queue 1004. Once the content stream generator 416 receives the currently eligible media item, the content stream generator 416 can add the media item to the next available slot in the content stream 1008.

When the content stream generator 416 detects the occurrence of an invitational content triggering event, the content stream generator 416 can request an item of invitational content from the invitational content rule engine 414. In response to the request from the content stream generator 416, the invitational content rule engine 414 can obtain one or more rules applicable to the media station from the invitational content playback rules database 436. The invitational content rule engine 414 can then apply the one or more obtained rules to the list of candidate invitational content items 1006. If the invitational content rule engine 414 identifies a currently eligible invitational content item, the invitational content rule engine 414 can send the invitational content item to the content stream generator 416. Once the content stream generator 416 receives an invitational content item, the content stream generator 416 can add the item to the next available slot in the content stream 1008.

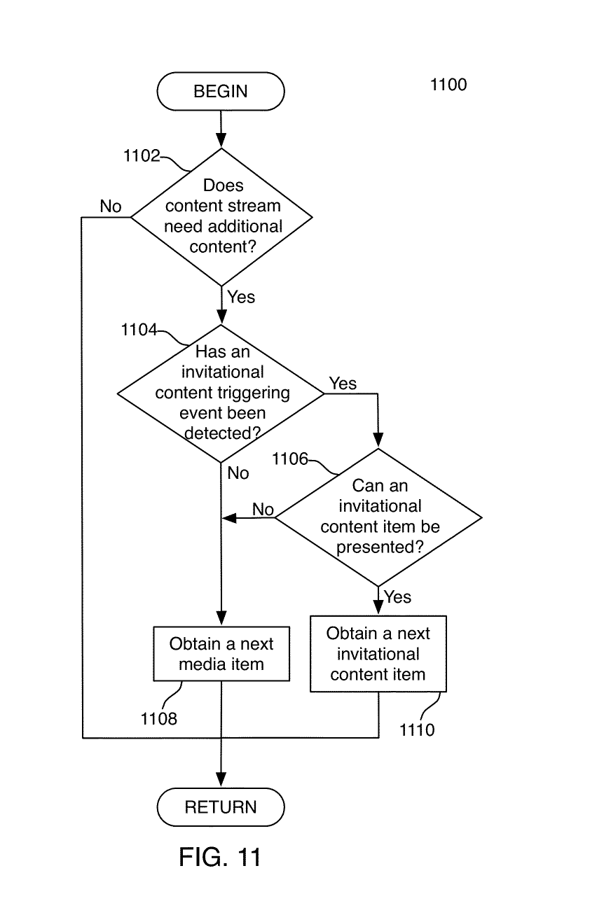

FIG. 11 is a flowchart illustrating steps in an exemplary method 1100 for generation a media station on a client device. For the sake of clarity, this method is discussed in terms of an exemplary client device 102 in FIG. 5. Although specific steps are shown in FIG. 11, in other embodiments a method can have more or less steps than shown.

The client device 102 can check if the content stream used by the media station needs additional content (1102). In some cases, the content stream can be similar to a playback buffer in that a minimum amount of content can be buffered to ensure consistent playback. Therefore, the client device 102 can be configured to require a minimum amount of content in the content stream. For example, the client device 102 can be configured to add a next content item, e.g. media item or invitational content item, to the content stream when the current content item has ten seconds of playback time remaining and the content stream does not contain any additional content items. When the minimum is reached, the client device 102 can fill the content stream with one or more media items and/or one or more invitational content items. If the client device 102 determines that additional content is needed, the client device can check if an invitational content triggering event has occurred (1104). If an invitational content triggering event has occurred, the client device 102 can determine whether an item of invitational content can be presented by applying one or more invitational content playback rules (1106). If an invitational content item can be presented, the client device 102 can obtain a next invitational content item (1110), otherwise the client device 102 can obtain a next media item (1108). After determining that the content stream does not need additional content, or after adding additional content, the client device 102 can resume previous processing, which can include repeating method 1100.

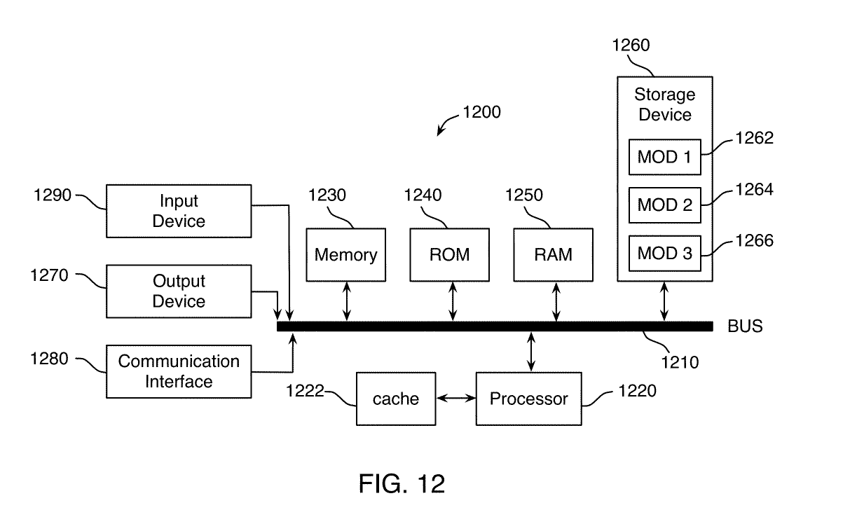

With reference to FIG. 12, an exemplary system 1200 includes a general-purpose computing device 1200, including a processing unit (CPU or processor) 1220 and a system bus 1210 that couples various system components including the system memory 1230 such as read only memory (ROM) 1240 and random access memory (RAM) 1250 to the processor 1220. The system 1200 can include a cache 1222 connected directly with, in close proximity to, or integrated as part of the processor 1220. The system 1200 copies data from the memory 1230 and/or the storage device 1260 to the cache for quick access by the processor 1220. In this way, the cache provides a performance boost that avoids processor 1220 delays while waiting for data. These and other modules can control or be configured to control the processor 1220 to perform various actions. Other system memory 1230 may be available for use as well. The memory 1230 can include multiple different types of memory with different performance characteristics. It can be appreciated that the disclosure may operate on a computing device 1200 with more than one processor 1220 or on a group or cluster of computing devices networked together to provide greater processing capability. The processor 1220 can include any general purpose processor and a hardware module or software module, such as module 1 1262, module 2 1264, and module 3 1266 stored in storage device 1260, configured to control the processor 1220 as well as a special-purpose processor where software instructions are incorporated into the actual processor design. The processor 1220 may essentially be a completely self-contained computing system, containing multiple cores or processors, a bus, memory controller, cache, etc. A multi-core processor may be symmetric or asymmetric.

The system bus 1210 may be any of several types of bus structures including a memory bus or memory controller, a peripheral bus, and a local bus using any of a variety of bus architectures. A basic input/output (BIOS) stored in ROM 1240 or the like, may provide the basic routine that helps to transfer information between elements within the computing device 1200, such as during start-up. The computing device 1200 further includes storage devices 1260 such as a hard disk drive, a magnetic disk drive, an optical disk drive, tape drive or the like. The storage device 1260 can include software modules 1262, 1264, 1266 for controlling the processor 1220. Other hardware or software modules are contemplated. The storage device 1260 is connected to the system bus 1210 by a drive interface. The drives and the associated computer readable storage media provide nonvolatile storage of computer readable instructions, data structures, program modules and other data for the computing device 1200. In one aspect, a hardware module that performs a particular function includes the software component stored in a non-transitory computer-readable medium in connection with the necessary hardware components, such as the processor 1220, bus 1210, output device 1270, and so forth, to carry out the function. The basic components are known to those of skill in the art and appropriate variations are contemplated depending on the type of device, such as whether the device 1200 is a small, handheld computing device, a desktop computer, or a computer server.

Although the exemplary embodiment described herein employs the hard disk 1260, it should be appreciated by those skilled in the art that other types of computer readable media which can store data that are accessible by a computer, such as magnetic cassettes, flash memory cards, digital versatile disks, cartridges, random access memories (RAMs) 1250, read only memory (ROM) 1240, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 1200, an input device 190 represents any number of input mechanisms, such as a microphone for speech, a touch-sensitive screen for gesture or graphical input, keyboard, mouse, motion input, speech and so forth. An output device 1270 can also be one or more of a number of output mechanisms known to those of skill in the art. In some instances, multimodal systems enable a user to provide multiple types of input to communicate with the computing device 1200. The communications interface 1280 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 1220. The functions these blocks represent may be provided through the use of either shared or dedicated hardware, including, but not limited to, hardware capable of executing software and hardware, such as a processor 1220, that is purpose-built to operate as an equivalent to software executing on a general purpose processor. For example the functions of one or more processors presented in FIG. 12 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 1240 for storing software performing the operations discussed below, and random access memory (RAM) 1250 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 1200 shown in FIG. 12 can practice all or part of the recited methods, can be a part of the recited systems, and/or can operate according to instructions in the recited non-transitory computer-readable storage media. Such logical operations can be implemented as modules configured to control the processor 1220 to perform particular functions according to the programming of the module. For example, FIG. 12 illustrates three modules Mod1 1262, Mod2 1264 and Mod3 1266 which are modules configured to control the processor 1220. These modules may be stored on the storage device 1260 and loaded into RAM 1250 or memory 1230 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer implemented method for generating on a client device a media stream corresponding to a media channel, the method comprising:
caching a first list of candidate media items, the first list comprising media item identifiers, each media item identifier representing a candidate media item and associated with metadata descriptive of the candidate media item;
caching a list of candidate invitational content, each candidate invitational content item associated with metadata descriptive of the candidate invitational content item;
selecting a first media item identifier from the first list of candidate media items and applying at least one media playback rule to generate a playback eligibility value for the first media item identifier; and
in response to detecting an occurrence of an invitational content trigger event, applying at least one invitational content rule to the list of candidate invitational content to identify at least one invitational content item.

2. The method of claim 1 further comprising:
caching a second list of candidate media items in response to detecting a change in the media channel; and
selecting a second media item identifier from the second list of candidate media items and applying at least one media playback rule to generate a playback eligibility value for the second media item identifier.

3. The method of claim 1 further comprising:
updating the list of candidate invitational content in response to detecting a number of invitational content items in the list falling below a predefined threshold value.

4. The method of claim 1, wherein each media item identifier is further associated with a reference to a media item associated with the client device.

5. The method of claim 4, wherein the reference is a reference to a media item in a media library accessible to the client device.

6. The method of claim 4, wherein the reference is a reference to a media item cached on the client device for playback in the media stream.

7. The method of claim 1, wherein an invitational content triggering event includes at least one of a media station player application launch, media item playback completion, a user interaction with the media stream, a media channel initiation, predefined movement detection, proximity detection, or a switch from a first media channel to a second media channel.

8. The method of claim 1, wherein presenting a selected invitational content item comprises preventing playback of a next media item while presenting the selected invitational content item.

9. A non-transitory computer-readable storage medium which, when executed by a computing device, causes the computing device to perform steps comprising:
generating a content stream for a media channel including a mix of media items from a cached media playlist and invitational content items from a cached invitational content playlist, wherein generating the content stream comprises:
building a play queue based on applying one or more media playback rules to the cached media playlist, wherein the applying identifies a media item currently eligible for playback,
in response to detecting an invitational content triggering event, identifying at least one invitational content item by applying one or more invitational content playback rules to the invitational content playlist, and adding the at least one identified invitational content item to the content stream, and
adding a next media item based on the play queue to the content stream.

10. The non-transitory computer-readable storage medium of claim 9 further comprising:
receiving the cached media playlist from a media server, the cached media playlist specific to the media channel, wherein each media item in the media playlist satisfying one or more media playlist generation rules applicable to the media channel; and
receiving the cached invitational content playlist from an invitational content server, the cached invitational content playlist corresponding to the media channel, wherein each invitational content item in the invitational content playlist satisfying one or more invitational content playlist generation rules applicable to the media channel.

11. The non-transitory computer-readable storage medium of claim 10, wherein at least one of the one or more invitational content playlist generation rules is based on user characteristics.

12. The non-transitory computer-readable storage medium of claim 9 further comprising:
updating the one or more media playback rules based on user input.

13. The non-transitory computer-readable storage medium of claim 12, wherein the user input is at least one of a like or a ban of a media item.

14. The non-transitory computer-readable storage medium of claim 9, wherein at least one of the one or more media playback rules is media channel independent.

15. A system comprising:
a processor;
a storage medium configured to store a candidate media item playlist, a candidate invitational content item playlist, one or more media playback rules, and one or more invitational content item playback rules;
a media playback rule engine configured to control the processor to apply one or more media playback rules to the candidate media item playlist to generate a currently eligible media item, and adding the currently eligible media item to a play queue;
an invitational content item playback rule engine configured to control the processor to apply one or more invitational content item playback rules to the candidate invitational content item playlist to select an invitational content item, the rule engine invoked in response to detecting an invitational content item triggering event; and
a media stream updater configured to control the processor to update a media stream by adding at least one of a next media item in the play queue or the selected invitational content item.

16. The system of claim 15, wherein an available selected invitational content item is added to the media stream prior to adding a next media item from the play queue.

17. The system of claim 15, wherein the media playback rule engine is invoked in response to detecting at least one of initiation of a new media stream or the near completion of a currently playing media item.

18. The system of claim 15 further comprising:
a storage updater module configured to control the processor to update at least one the candidate media item playlist, the candidate invitational content item playlist, one or more media playback rules, and one or more invitational content playback rules in response to detecting an initiation of a new media stream.

19. A computer implemented method comprising:
receiving a list of candidate media items corresponding to a media channel, the list of candidate media items including media item identifiers, each media item identifier in the list of candidate media items corresponding to a candidate media item, each candidate media item being locally available;
obtaining a candidate media item identifier from the list of candidate media items;
applying one or more media playback rules to the candidate media item, the one or more media playback rules determining a current eligibility for playback on the media channel; and
in response to determining the candidate media item is currently eligible for playback, adding the candidate media item to a play queue.

20. The method of claim 19 further comprising:
selecting an invitational content item from a cached list of candidate invitational content items, the selecting occurring in response to detecting an invitational content triggering event, the selecting comprising applying one or more invitational content item playback rules to the cached list of candidate invitational content items.

21. The method of claim 19 further comprising:
updating the cached list of candidate media items when a number of media item identifiers in the list drops below a threshold value.

22. The method of claim 19, wherein the play queue represents a play history and wherein at least one of the one or more media item playback rules is based on play history.

23. The method of claim 19, wherein the play represents a play history and wherein at least one of the one or more media item playback rules specifies a maximum number of media items from an album in a time period.

24. The method of claim 19, wherein a playback rule specifies a maximum number of media item skips in a time period.

25. The method of claim 19, wherein the media channel is user specific and wherein the list of candidate media items is based on at least one of demographic data, purchase history data, or user media library data.

26. The method of claim 19, wherein the media channel is based on a seed item and wherein the list of candidate media items is based on a measure of similarity to the seed item.

27. The method of claim 20, wherein the media channel is curated and wherein at least one of the one or more media item playback rules is specified by a sponsor of the media channel.

28. The method of claim 27, wherein at least one of the one or more invitational content item playback rules is specified by the sponsor of the media channel.

29. A computer implemented method comprising:
receiving a list of candidate invitational content items corresponding to a media channel, each candidate invitational content item being locally available;
selecting an invitational content item from the list of candidate invitational content items, the selecting occurring in response to detecting an invitational content trigger event, wherein selecting comprises applying one or more invitational content item playback rules to the cached list of candidate invitational content items;
presenting the selected invitational content item within the media channel, the presenting delaying playback of a next media item.

30. The method of claim 29, wherein an invitational content triggering event includes at least one of a media station player application launch, a media item playback completion, a user interaction with the media stream, a media channel initiation, predefined movement detection, proximity detection, or a change in the media channel.

31. The method of claim 29 further comprising:
beginning playback of a media item identified from a locally stored play queue, the media item added to the play queue based on applying one or more media playback rules to a locally stored candidate media playlist, wherein the applying identifies a media item currently eligible for playback.

32. The method of claim 29, wherein the list of candidate invitational content items includes invitational content targeted to the client device.

33. The method of claim 29, wherein the media channel has associated metadata, the metadata descriptive of the media channel.

34. The method of claim 33, wherein at least one of the one or more invitational content rules matches candidate invitational content metadata with the media channel metadata.

35. The method of claim 29, wherein at least one of the one or more invitational content rules matches candidate invitational content metadata with metadata associated with a currently playing media item.

36. The method of claim 29, wherein at least one of the one or more invitational content rules matches candidate invitational content metadata with metadata associated with a next media item, the next media item being a media item next in a play queue.

37. The method of claim 29, wherein at least one of the one or more invitational content rules specifies at least one of a minimum time period between presenting a first invitational content item and a second invitational content item, a maximum time period between presenting a first invitational content item and a second invitational content item, or a number of media items played between a first invitational content item and a second invitational content item.
